(19) United States
(12) Patent Application Publication
(10) Pub. No.: US 2026/0302011 A1
(43) Pub. Date: Oct. 1, 2026

(54) PERMANENT MAGNET

(71) Applicants: LG INNOTEK CO., LTD., Seoul (KR); KOREA INSTITUTE OF MATERIALS SCIENCE, Changwon-si, Gyeongsangnam-do (KR)

(72) Inventors: Kwang Ki CHOI, Seoul (KR); Seok BAE, Seoul (KR); Hyun seok LIM, Seoul (KR); Jung Goo LEE, Seongnam-si (KR); Tae Hoon KIM, Changwon-si (KR); Seol Mi LEE, Changwon-si (KR); Min Ae OUK, Seoul (KR)

(73) Assignees: LG INNOTEK CO., LTD., Seoul (KR); KOREA INSTITUTE OF MATERIALS SCIENCE, Changwon-si, Gyeongsangnam-do (KR)

(21) Appl. No.: 19/490,265

(22) PCT Filed: Jun. 5, 2024
(86) PCT No.: PCT/KR2024/007748

§ 371 Date: Dec. 4, 2025

(30) Foreign Application Priority Data
Jun. 5, 2023 (KR) 10-2023-0072290
Oct. 11, 2023 (KR) 10-2023-0135134

(51) Int. Cl. H01F 1/057; C22C 28/00

(52) U.S. Cl. CPC H01F 1/0571; C22C 28/00

(57) ABSTRACT

A permanent magnet according to an embodiment includes a Re—Fe—B base magnet; and a grain boundary diffusion metal disposed inside the base magnet, wherein the base magnet includes a plurality of crystal grains, and a grain boundary between the plurality of crystal grains, the grain boundary diffusion metal includes a praseodymium (Pr)—X—Y alloy disposed at the grain boundary, the X includes at least one metal selected from copper (Cu), aluminum (Al), and gallium (Ga), and the Y includes at least one metal selected from titanium (Ti), tungsten (W), niobium (Nb), rhenium (Re), and molybdenum (Mo).

### TECHNICAL FIELD

The embodiment relates to a permanent magnet and a method of manufacturing the same.

### BACKGROUND ART

A Re—Fe—B based magnet is a permanent magnet including a rare earth element and a compound of iron and boron (B). The rare earth (Re) may include neodymium (Nd), praseodymium (Pr), dysprosium (Dy), cerium (Ce), or terbium (Tb).

The permanent magnet is used in fields such as electronic information, automobile industry, medical device, energy or transportation. Recently, the permanent magnet is also used in electronic information devices, home appliances, mobile phones, robot motors, wind power generators, small motors for automobiles, or drive motors.

A post-treatment method for improving a magnetic performance of the permanent magnet has been proposed. For example, the post-treatment method includes coating and heat treating a heavy rare earth element on a surface of the permanent magnet. Accordingly, the heavy rare earth element can be concentrated and distributed around a grain boundary. Accordingly, a coercive force can be improved.

However, there is a problem in that it is difficult to supply and demand the heavy rare earth element. In addition, the heavy rare earth element has a high melting point. As a result, a diffusion rate of the heavy rare earth element decreases, so process efficiency may deteriorate.

In addition, there is a problem in that a size of a crystal grain of the permanent magnet increases in a high-temperature process. Accordingly, the coercive force of the permanent magnet may be reduced.

Therefore, a Re—Fe—B based permanent magnet with a new structure that can solve the above problems is required.

Korean Patent No. 10-1932551 is disclosed as a prior document related to the permanent magnet.

### DISCLOSURE

### Technical Problem

Embodiments provide permanent magnets with improved coercivity.

### Technical Solution

A permanent magnet according to an embodiment includes a Re—Fe—B base magnet; and a grain boundary diffusion metal disposed inside the base magnet, wherein the base magnet includes a plurality of crystal grains, and a grain boundary between the plurality of crystal grains, the grain boundary diffusion metal includes a praseodymium (Pr)—X—Y alloy disposed at the grain boundary, the X includes at least one metal selected from copper (Cu), aluminum (Al), and gallium (Ga), and the Y includes at least one metal selected from titanium (Ti), tungsten (W), niobium (Nb), rhenium (Re), and molybdenum (Mo).

### Advantageous Effects

A permanent magnet according to an embodiment include a grain boundary diffusion metal. The grain boundary diffusion metal is disposed at a grain boundary of the permanent magnet.

The grain boundary diffusion metal includes a grain boundary diffusion material having a set composition and composition ratio. In detail, the grain boundary diffusion material includes a Pr—X—Y alloy.

The X includes copper (Cu), aluminum (Al), and gallium (Ga). The praseodymium (Pr) and the X metal form an alloy. Thereby, a melting point of the grain boundary diffusion material decreases. Therefore, the grain boundary diffusion material can diffuse at a low temperature. Accordingly, a diffusion rate of the grain boundary diffusion material increases, thereby improving process efficiency.

In addition, the embodiment can prevent coarsening of crystal grains of the permanent magnet. In detail, the embodiment can prevent adjacent crystal grains from reacting with each other due to high temperature. Accordingly, since coarsening of the crystal grains is prevented, a coercive force of the permanent magnet is improved.

The Y may include at least one metal selected from titanium (Ti), tungsten (W), niobium (Nb), rhenium (Re), and molybdenum (Mo). For example, Y includes titanium (Ti).

The titanium (Ti) may form a precipitate phase at the grain boundary. Thereby, reaction of adjacent crystal grains is prevented by the precipitated phase. Therefore, the embodiment can prevent coarsening of the crystal grains. Accordingly, the embodiment can improve the coercive force of the permanent magnet.

### BRIEF DESCRIPTION OF DRAWINGS

FIG. 1 is a perspective view of a permanent magnet according to an embodiment.

FIGS. 2 and 3 are cross-sectional views for explaining an inside of a permanent magnet according to an embodiment.

FIG. 4 is an enlarged view of region A of FIG. 3.

FIG. 5 is a graph for explaining a relative ratio of contents of elements and compounds in a B-B′ region of FIG. 4.

FIGS. 6 and 7 are graphs for explaining a coercive force of a permanent magnet according to an embodiment.

FIG. 8 is a diagram for explaining differences in crystal grains depending on a depth of permanent magnets according to examples and comparative examples.

### MODES OF THE INVENTION

Hereinafter, embodiments of the present disclosure will be described in detail with reference to the accompanying drawings. However, the spirit and scope of the present disclosure is not limited to a part of the embodiments described, and may be implemented in various other forms, and within the spirit and scope of the present disclosure, one or more of the elements of the embodiments may be selectively combined and replaced.

In addition, unless expressly otherwise defined and described, the terms used in the embodiments of the present disclosure (including technical and scientific terms) may be construed the same meaning as commonly understood by one of ordinary skill in the art to which the present disclosure belongs, and the terms such as those defined in commonly used dictionaries may be interpreted as having a meaning that is consistent with their meaning in the context of the relevant art.

Hereinafter, a permanent magnet according to an embodiment will be described with reference to the drawings.

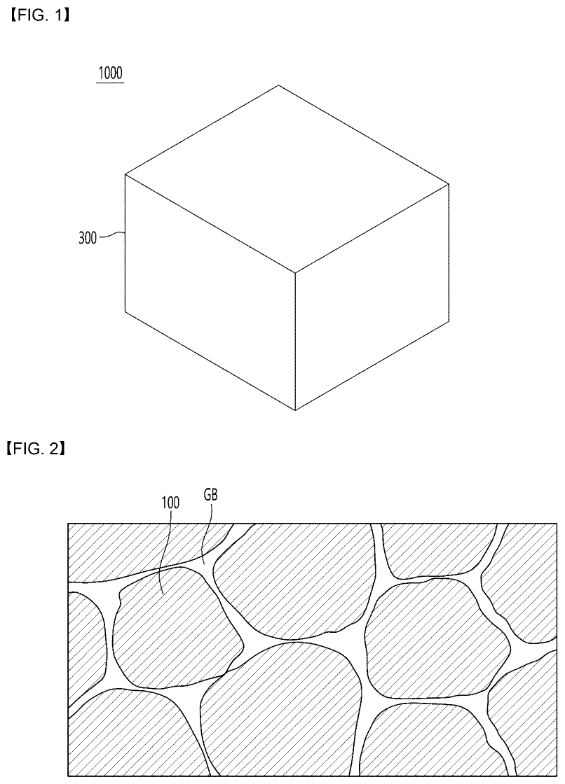

Referring to FIGS. 1 to 5, a permanent magnet 1000 includes a base magnet 300. The base magnet 300 may include a Re—Fe—B-based permanent magnet. The Re may include a rare earth element. For example, the Re may include neodymium (Nd), praseodymium (Pr), dysprosium (Dy), cerium (Ce), or terbium (Tb).

The base magnet 300 is formed by sintering a magnet powder. For example, gray earth oxide, iron, boron, and a reducing agent are mixed and then heated. As a result, the rare earth oxide is reduced to form Re₂Fe₁₄B magnet powder. Subsequently, the magnetic powder is formed by heating the magnet power at a set range temperature.

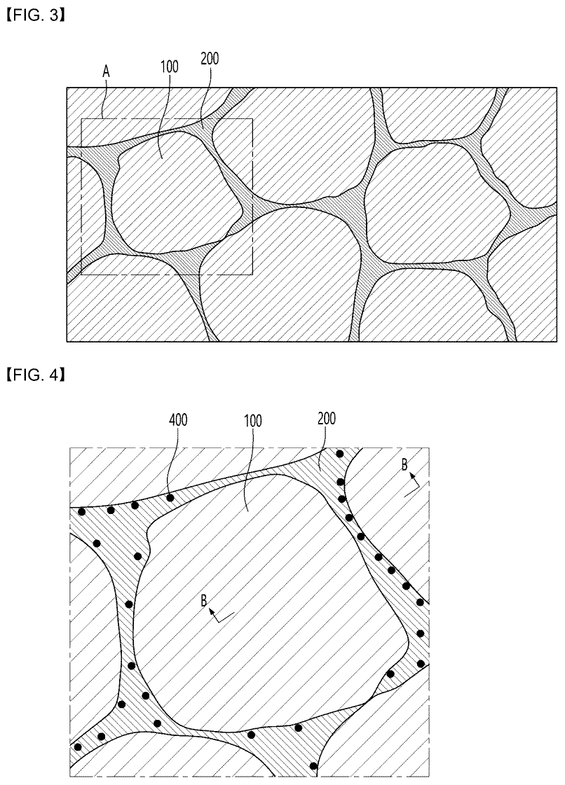

Referring to FIG. 2, the base magnet 300 forms a plurality of crystal grains 100 by the process of sintering. Accordingly, a boundary is formed between adjacent crystal grains. That is, a grain boundary (GB) is formed between adjacent crystal grains. Therefore, the base magnet 300 includes a plurality of crystal grains 100 and a grain boundary between the crystal grains.

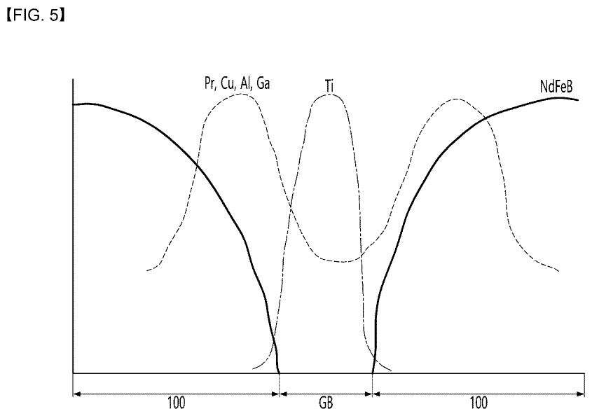

Referring to FIGS. 3 and 4, a grain boundary diffusion metal 200 is disposed at the grain boundary GB. For example, a grain boundary diffusion material is coated on the surface of the permanent magnet. Subsequently, the embodiment performs heat treatment at a temperature in a set range. Accordingly, the grain boundary diffusion material is diffused into the permanent magnet. Specifically, the grain boundary diffusion material is diffused into the grain boundary. Accordingly, the grain boundary diffusion metal 200 is disposed at the grain boundary GB.

The grain boundary diffusion metal 200 includes a material having a set composition and a set composition ratio.

The grain boundary diffusion metal 200 includes a light earth material. For example, the grain boundary diffusion metal 200 may include praseodymium (Pr). For example, the grain boundary diffusion metal 200 may include a metal compound containing praseodymium (Pr). Specifically, the grain boundary diffusion metal 200 may include a Pr—X—Y alloy. That is, the grain boundary diffusion metal 200 may include a metal alloy containing Pr, X and Y.

The X includes at least one metal. For example, the X may include at least one metal among copper (Cu), aluminum (Al), and gallium (Ga). For example, the X includes copper (Cu), aluminum (Al), and gallium (Ga).

The Y includes at least one metal. For example, the Y may include a Refractory Metal. For example, the Y may include at least one metal selected among titanium (Ti), tungsten (W), niobium (Nb), rhenium (Re), and molybdenum (Mo). For example, the Y includes titanium (Ti).

The grain boundary diffusion metal 200 has a predetermined composition ratio. The composition ratio of the grain boundary diffusion metal is represented by atomic percent. Specifically, an atomic percent ratio of Pr and (X+Y) may range from 6.5(Pr):3.5(X+Y) to 7.5(Pr):2.5(X+Y). Furthermore, the atomic percent ratio of Pr, X and Y may range from 6.5(Pr):3.49(X):0.01(Y) to 7.5(Pr):2.1(X):0.4(Y). A melting point of the grain boundary diffusion metal 200 is reduced by the composition ratio. Additionally, a coercive force of the permanent magnet increases with the composition ratio.

For example, the X may include copper (Cu), aluminum (Al), and gallium (Ga). In addition, the Y may include titanium (Ti). That is, the grain boundary diffusion metal 200 may include a Pr—Cu—Al—Ga—Ti alloy.

When the atomic percent of the metal compound is 100 at %, the atomic percent of praseodymium (Pr) is greater than the atomic percent of X and Y. Specifically, the atomic percent of praseodymium (Pr) is greater than the sum of atomic percent of copper (Cu), aluminum (Al), gallium (Ga), and titanium (Ti).

The praseodymium (Pr) has a set atomic percent. Specifically, the praseodymium (Pr) is contained in an amount of 65 at % or more. More specifically, the praseodymium (Pr) is contained in an amount of 65 at % to 75 at %.

The praseodymium (Pr) is diffused into the permanent magnet. In detail, the praseodymium (Pr) is diffused into the permanent magnet through the grain boundary (GB). Thereby, the coercive force of the permanent magnet is improved.

If an amount of praseodymium (Pr) is less than 65 at %, the coercive force of the permanent magnet may decrease. Furthermore, if an amount of praseodymium (Pr) exceeds 75 at %, a ratio of the X metal decreases. Accordingly, the melting point of the metal compound may increase. Thus, a diffusion rate of the grain boundary diffusion metal may decrease. Accordingly, the process efficiency of the permanent magnet may decrease. Furthermore, the heat treatment temperature of the grain boundary diffusion metal may increase. Accordingly, the crystal grain may become coarse. Thus, the coercive force of the permanent magnet may decrease.

The X has an atomic percent of a set range. Specifically, the X is contained in 20 at % or more. In more detail, the X is contained in an amount of 20 at % to less than 35 at %.

The X includes at least one metal among copper (Cu), aluminum (AI), and gallium (Ga). X is alloyed with Pr. Therefore, the melting point of the metal compound is reduced. That is, the melting point of the metal compound is reduced by the X metal. Accordingly, since the diffusion rate of the metal compound is increased, the process efficiency of the permanent magnet is improved. In addition, the grain boundary diffusion material is diffused at a low temperature. Accordingly, it is possible to prevent the crystal grains from coarsening due to high temperature. Accordingly, the coercive force of the permanent magnet is increased.

For example, the X includes copper (Cu), aluminum (Al), and gallium (Ga). Each of the copper (Cu), the aluminum (Al), and the gallium (Ga) has an atomic percent in a set range.

For example, the atomic percent of copper (Cu) is greater than the atomic percent of the aluminum (Al) and the gallium (Ga). Specifically, the copper (Cu) is included in an amount of 10 at % or more. More specifically, the copper (Cu) is included in an amount of 10 at % to 20 at %.

The atomic percent of the aluminum (Al) may be greater or less than the atomic percent of the gallium (Ga). For example, the atomic percent of the aluminum (Al) may be greater than the atomic percent of the gallium (Ga). Specifically, the aluminum (Al) is included in an amount of 5 at % or more. In more detail, the aluminum (Al) is included in an amount of 5 at % to 15 at %.

The atomic percent of the gallium (Ga) may be greater or less than the atomic percent of the aluminum (Al). For example, the atomic percent of the gallium (Ga) may be less than the atomic percent of the aluminum (Al). Specifically, the gallium (Ga) is included in an amount of 0.1 at % or more. In more detail, the gallium (Ga) is included in an amount of 0.7 at % to 7 at %.

The gallium (Ga) forms a non-magnetic phase on the grains around the grain boundary. For example, the gallium (Ga) forms an Nd₆Fe₁₃Ga phase on the grains around the grain boundary. Accordingly, non-magnetic properties of the grains of the permanent magnet are improved. Accordingly, since the coercive force of the permanent magnet is increased, the magnetic performance of the permanent magnet is improved.

The copper (Cu) and the aluminum (Al) promote the improvement of the coercive force increase achieved by the gallium (Ga). In detail, a content of iron (Fe) in the permanent magnet is reduced by the gallium (Ga). Accordingly, the permanent magnet has an Nd₆Fe₁₃Ga phase of Nd-rich. The copper (Cu) and the aluminum (Al) further increase the non-magnetic properties of crystal grains of the permanent magnet having the Nd₆Fe₁₃Ga phase of Nd-rich. Accordingly, the coercive force of the permanent magnet may be increased.

The Y has an atomic percent in a set range. Specifically, the Y is included in an amount of 0.1 at % or more. More specifically, the Y is included in an amount of 0.1 at % to 4 at %.

The Y may include at least one metal among titanium (Ti), tungsten (W), niobium (Nb), rhenium (Re), and molybdenum (Mo). For example, the Y includes titanium (Ti), tungsten (W), niobium (Nb), rhenium (Re), or molybdenum (Mo). For example, the Y includes titanium (Ti).

The Y is disposed at the grain boundary. The Y forms a precipitation phase 400 at the grain boundary. The precipitation phase 400 may prevent a reaction of adjacent crystal grains. For example, the Y may include titanium (Ti). The titanium (Ti) precipitates at the grain boundary. Accordingly, a Ti precipitation phase is formed at the grain boundary. Accordingly, the reaction of adjacent crystal grains is prevented by the titanium precipitation phase 400. Accordingly, it is possible to prevent the crystal grains from coarsening due to the reaction of adjacent grains.

The Y prevents the crystal grains 200 from being coarsened. Thus, the crystal grains of the permanent magnet are prevented from becoming larger. Thus, the coercive force of the permanent magnet is improved.

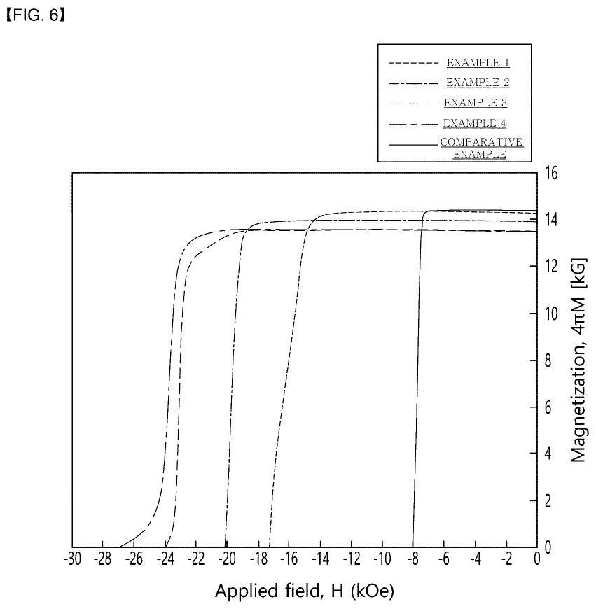

FIG. 5 is a graph for explaining a ratio of the permanent magnet and the metal compound. FIG. 5 is a graph when the permanent magnet includes Nd—Fe—B, the X metal includes copper (Cu), the aluminum (Al), and the gallium (Ga), and the Y metal includes titanium (Ti).

The elements of the metal compound are contained in different ratios in the Nd—Fe—B crystal grain and grain boundary (GB). Specifically, the ratio of the Pr, Cu, Al, and Ga elements to each position may be different from the ratio of the Ti element to each position.

Referring to FIG. 5, the content of Re—Fe—B decreases toward the grain boundary (GB) direction. For example, the Nd—Fe—B decreases toward the grain boundary (GB) direction from the crystal grain. That is, the Nd—Fe—B is disposed only on the crystal grain 100.

In addition, the contents of the Pr, Cu, Al, and Ga elements include a region which increases from the crystal grain toward the grain boundary (GB). In addition, the contents of the Pr, Cu, Al, and Ga elements include a region in which decreases at the grain boundary (GB). That is, the Pr, Cu, Al, and Ga elements are partially diffused from the grain boundary (GB) to the grain 100.

In addition, the Ti element includes a region in which increases and decreases at the grain boundary (GB). That is, the Ti element is disposed at the grain boundary (GB).

In a region adjacent to a center of the crystal grain, a ratio of the Re—Fe—B is greater than the ratio of the Pr, Cu, Al, and Ga elements. For example, a ratio of the Nd—Fe—B is greater than the ratio of the Pr, Cu, Al, and Ga elements. Also, in a region far from the center of the crystal grain, that is, a region adjacent to the grain boundary (GB), the ratio of the Pr, Cu, Al, and Ga elements is greater than the ratio of the Re—Fe—B.

The Pr, Cu, Al, and Ga elements diffuse from the grain boundary (GB) and penetrate into the inside of the crystal grain. Accordingly, in a crystal grain region around the grain boundary (GB), the ratio of the Pr, Cu, Al, and Ga elements is greater than the ratio of the Nd—Fe—B.

In the grain boundary (GB), the ratio of the Ti element is a greatest. The Ti element hardly penetrates into an inside of the Nd—Fe—B crystal grain. Accordingly, most Ti elements are disposed at the grain boundary (GB). Accordingly, the Ti element may be precipitated from the grain boundary (GB). The reaction of the adjacent crystal grains 200 is reduced by the Ti precipitation phase precipitated from the grain boundary (GB). Therefore, coarsening of the crystal grain 200 is prevented.

Accordingly, a particle diameter deviation of the crystal grains of the permanent magnet may be reduced. Specifically, a difference between a maximum particle diameter and a minimum particle diameter of the crystal grains 200 of the permanent magnet may be 30% or less. In more detail, the difference between the maximum particle diameter and the minimum particle diameter of the crystal grains 200 may be 5% to 30%, 10% to 25%, or 15% to 20%.

Accordingly, the particle diameter of the crystal grains of the permanent magnet becomes uniform. Accordingly, the coercive force of the permanent magnet is improved.

Hereinafter, magnetic properties of the permanent magnet according to the grain boundary diffusion material will be described through examples and comparative examples.

### Example 1

A base magnet is prepared. The base magnet is formed by sintering magnet powder. The base magnet is an Nd—Fe—B-based magnet. The base magnet has a size of 15×15×4(t), (mm), and has a weight of 6.77 g.

Subsequently, an adhesive material in which polyvinyl alcohol (PVA), ethanol, and water are mixed is applied to a surface of the base magnet.

Subsequently, a grain boundary diffusion material is applied to the surface of the base magnet. In detail, a grain boundary diffusion material having a composition and composition ratio of Pr₇₀Cu₁₅Al₁₀Ga₄Ti₁ (at %) is applied to the surface of the base magnet.

When the sum of a weight percent of the grain boundary diffusion material and the base magnet is 100 wt %, the grain boundary diffusion material is applied in an amount of 1 wt %.

The grain boundary diffusion material may be formed by melting a Pr₇₀Cu₁₅Al₁₀Ga₄Ti₁ alloy and melt spinning or jet milling in which the molten Pr₇₀Cu₁₅Al₁₀Ga₄Ti₁ is poured onto a wheel rotating at high speed and quenched.

Subsequently, the Pr₇₀Cu₁₅Al₁₀Ga₄Ti₁ alloy is well attached to the surface of the base magnet by drying the adhesive material using a heating gun or oven.

Subsequently, heat treatment is performed. The base magnet is subjected to a first heat treatment for 15 hours at a temperature of 970° C. in a vacuum state. Subsequently, the base magnet is subjected to a second heat treatment (an annealing) for 2 hours at a temperature of 550° C.

Thereby, an Nd—Fe—B-based permanent magnet is manufactured.

Subsequently, the coercive force of the permanent magnet is measured.

### Example 2

An Nd—Fe—B-based permanent magnet is manufactured in the same manner as in Example 1, except that the grain boundary diffusion material is applied at 2 wt %.

Subsequently, the coercive force of the permanent magnet is measured.

### Example 3

An Nd—Fe—B-based permanent magnet is manufactured in the same manner as in Example 1, except that the grain boundary diffusion material is applied at 3 wt %.

Subsequently, the coercive force of the permanent magnet is measured.

### Example 4

An Nd—Fe—B-based permanent magnet is manufactured in the same manner as in Example 1, except that the grain boundary diffusion material is applied at 4 wt %.

Subsequently, the coercive force of the permanent magnet is measured.

### Example 5

An Nd—Fe—B-based permanent magnet is manufactured in the same manner as in Example 1, except that the grain boundary diffusion material is applied at 8 wt %.

Subsequently, the coercive force of the permanent magnet is measured.

### Example 6

An Nd—Fe—B-based permanent magnet is manufactured in the same manner as in Example 1, except that the grain boundary diffusion material is applied at 12 wt %.

Subsequently, the coercive force of the permanent magnet is measured.

### Comparative Example 1

An Nd—Fe—B permanent magnet is manufactured without applying the grain boundary diffusion material.

Subsequently, the coercive force of the permanent magnet is measured.

### Comparative Example 2

An Nd—Fe—B-based permanent magnet is manufactured in the same manner as in Example 1, except that the grain boundary diffusion material includes Pr₇₀Cu₁₅Al₁₀Ga₅ and the grain boundary diffusion material is applied at 8 wt %.

Subsequently, the coercive force of the permanent magnet is measured.

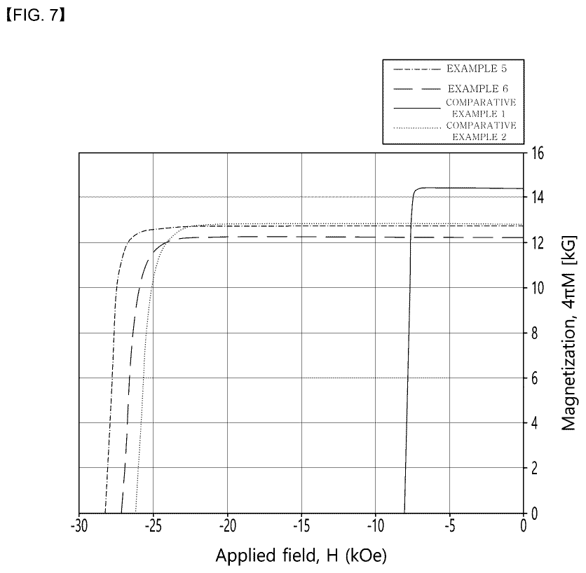

Referring to FIG. 6, the permanent magnets according to Examples 1 to 4 have improved coercive force compared to the permanent magnet according to Comparative Example 1.

The permanent magnet according to Comparative Example 1 does not include the grain boundary diffusion material. Accordingly, the permanent magnet according to Comparative Example 1 has a small coercive force of about 8 KOe.

In contrast, permanent magnets according to Examples 1 to 4 include a grain boundary diffusion material including Pr, Cu, Al, Ga, and Ti. Accordingly, the permanent magnet according to Examples has a coercive force of more than 8 KOe. That is, the coercive force of permanent magnets according to Examples is increased by the grain boundary diffusion material. Specifically, in the permanent magnet according to Examples, magnetization is not significantly reduced, and a coercive force is greatly increased.

Referring to FIG. 7, the permanent magnets according to Examples 5 and 6 have improved coercive force compared to the permanent magnets according to Comparative Examples 1 and 2.

The permanent magnet according to Comparative Example 1 does not include a grain boundary diffusion material. Accordingly, the permanent magnet according to Comparative Example 1 has a small coercive force of about 8 KOe.

A permanent magnet according to Comparative Example 2 includes a grain boundary diffusion material including Pr, Cu, Al, and Ga. That is, the grain boundary diffusion material of Comparative Example 2 does not include Ti. The permanent magnet of Comparative Example 2 has a coercive force of about 26 kOe.

On the other hand, permanent magnets according to Examples 5 and 6 include a grain boundary diffusion material including Pr, Cu, Al, Ga, and Ti. That is, the grain boundary diffusion material of Examples includes Ti. Accordingly, the coercive force of the permanent magnet is improved. Specifically, the permanent magnet according to Examples has a coercive force of more than 26 kOe. Specifically, the permanent magnet according to Examples has a coercive force of more than 26 kOe to 28 kOe. Specifically, the permanent magnet according to Examples does not significantly reduce magnetization, and the coercive force is greatly increased.

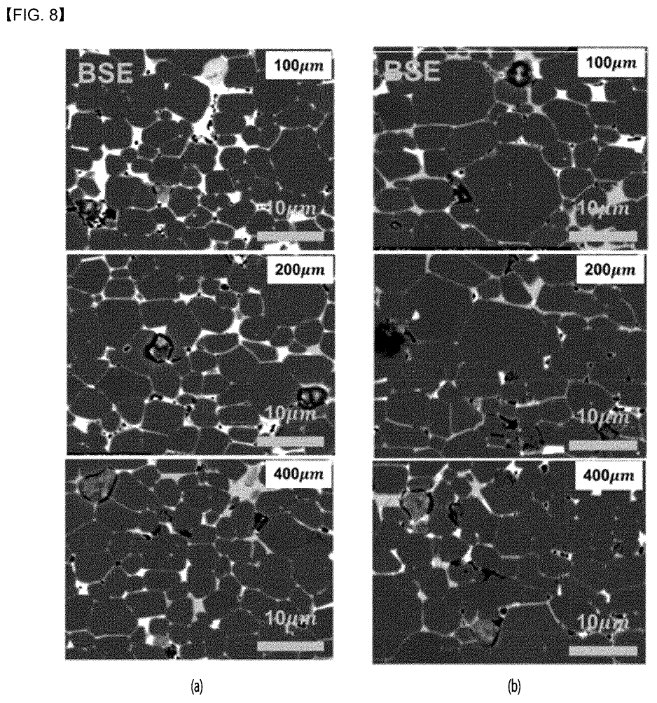

FIG. 8 is a view for explaining a difference in particle diameter between crystal grains of Example 5 and Comparative Example 2. FIG. 8 (a) is a particle diameter photograph of Example 5, and FIG. 8 (b) is a particle diameter photograph of Comparative Example 2.

Referring to FIG. 8, it may be seen that a particle diameter difference of the permanent magnet according to Example is small as a depth of the permanent magnet increases from a surface. Specifically, it may be seen that particle diameters of the crystal grains are similar at a depth of 100 μm, a depth of 200 μm, and a depth of 300 μm from the surface.

On the other hand, it may be seen that the permanent magnet according to Comparative Example has a large particle diameter difference as a depth thereof increases from the surface. Specifically, it may be seen that the particle diameter difference of the crystal grains is large at a depth of 100 μm, a depth of 200 μm, and a depth of 300 μm from the surface. Specifically, the particle diameter of the crystal grains at a depth of 100 μm from the surface is larger than the particle diameter of the crystal grains at a depth of 300 μm. That is, the permanent magnet according to Comparative Example does not include titanium (Ti), tungsten (W), niobium (Nb), rhenium (Re), or molybdenum (Mo), which prevents coarsening of crystal grains. Accordingly, while the grain boundary diffusion material is diffused, the crystal grains react with high temperature and become coarse. Accordingly, the coercive force of the permanent magnet decreases, as shown in FIG. 6.

Features, structures, effects, etc. described in the above embodiments are included in at least one embodiment, and it is not necessarily limited to only one embodiment. Furthermore, features, structures, effects, etc. illustrated in each embodiment can be combined or modified for other embodiments by those of ordinary skill in the art to which the embodiments belong. Accordingly, the contents related to such combinations and variations should be interpreted as being included in the scope of the embodiments.

In the above, the embodiment has been mainly described, but this is only an example and does not limit the embodiment, and those of ordinary skill in the art to which the embodiment pertains will appreciate that various modifications and applications not illustrated above are possible without departing from the essential characteristics of the present embodiment. For example, each component specifically shown in the embodiment can be implemented by modification. And the differences related to these modifications and applications should be interpreted as being included in the scope of the embodiments set forth in the appended claims.

1-10. (canceled)

11. A permanent magnet comprising:
a Re—Fe—B base magnet; and
a grain boundary diffusion metal disposed inside the base magnet,
wherein the base magnet includes a plurality of crystal grains, and a grain boundary between the plurality of crystal grains,
wherein the grain boundary diffusion metal includes a praseodymium (Pr)—X—Y alloy disposed at the grain boundary,
wherein an elemental content of the X includes a region in which the content increases from the crystal grain toward the crystal grain boundary, and
wherein an elemental content of each of the praseodymium and the X in the crystal grain boundary decreases as a distance from the crystal grain increases.

12. The permanent magnet of claim 11, wherein the X includes at least one metal selected from copper (Cu), aluminum (Al), and gallium (Ga), and
wherein the Y includes at least one metal selected from titanium (Ti), tungsten (W), niobium (Nb), rhenium (Re), and molybdenum (Mo).

13. The permanent magnet of claim 11, wherein the X includes copper (Cu), aluminum (Al), and gallium (Ga), and
wherein the Y includes titanium (Ti).

14. The permanent magnet of claim 13, wherein an atomic percent ratio of Pr and (X+Y) is 6.5(Pr):3.5(X+Y) to 7.5(Pr):2.5(X+Y).

15. The permanent magnet of claim 14, wherein an atomic percent ratio of Pr, X and Y is 6.5(Pr):3.49(X):0.01(Y) to 7.5(Pr):2.1(X):0.4(Y).

16. The permanent magnet of claim 15, wherein the Pr is contained at 65 at % to at %,
wherein the Cu is contained at 10 at % to 20 at %,
wherein the Al is contained at 5 at % to 15 at %,
wherein the Ga is contained at 0.7 at % to 7 at %, and
wherein the Ti is contained at 0.1 at % to 4 at %.

17. The permanent magnet of claim 13, wherein the Ti precipitates at the grain boundary.

18. The permanent magnet of claim 13, wherein a ratio of the Re—Fe—B in a region positioned close to a center of the crystal grain is greater than a ratio of the Pr, Cu, Al, and Ga elements in the region adjacent to the center of the crystal grain.

19. The permanent magnet of claim 18, wherein a ratio of the Pr, Cu, Al, and Ga elements in a region positioned close to the grain boundary is greater than a ratio of the Re—Fe—B in a region adjacent to the grain boundary.

20. The permanent magnet of claim 12, wherein a ratio of the Ti element is a greatest at the grain boundary.

21. The permanent magnet of claim 12, wherein a difference between a maximum particle size and minimum particle size of the crystal grains is 5% to 30%.

22. The permanent magnet of claim 13, wherein at least a portion of each of the copper (Cu), aluminum (Al), and gallium (Ga) diffuses from the grain boundary into the crystal grain.

23. The permanent magnet of claim 11, wherein the Re includes neodymium (Nd), praseodymium (Pr), dysprosium (Dy), cerium (Ce), or terbium (Tb).

24. The permanent magnet of claim 11, wherein the grain boundary includes a region in which elemental ratios of Pr, X, and Y are equal.

25. The permanent magnet of claim 24, wherein the region includes a first region and a second region, and
wherein an elemental ratio of the Y between the first region and the second region is greater than the elemental ratios of Pr and X.

26. The permanent magnet of claim 25, wherein an elemental ratio of the Y between the first region and the second region increases as a distance from the first region and the second region increases.
